(19) United States
(12) Patent Application Publication
(10) Pub. No.: US 2023/0366107 A1
(43) Pub. Date: Nov. 16, 2023

(54) GREEN AND BLUE HYDROGEN ALTERNATIVES TO PRODUCED WATER MANAGEMENT AND BENEFICIAL REUSE

(71) Applicant: CHEVRON U.S.A. INC., San Ramon, CA (US)

(72) Inventor: Frederick Verner, San Ramon, CA (US)

(21) Appl. No.: 18/095,893

(22) Filed: Jan. 11, 2023

Related U.S. Application Data
(60) Provisional application No. 63/298,516, filed on Jan. 11, 2022.
(60) Provisional application No. 63/339,122, filed on May 6, 2022.

(51) Int. Cl. C25B 1/04; C25B 15/08; C02F 1/58; C01B 3/24

(52) U.S. Cl. CPC C25B 1/04; C25B 15/085; C02F 1/58; C01B 3/24; C02F 2101/10

(57) ABSTRACT

The present disclosure refers to systems and methods for remediating a produced water from an oil or gas well. A representative process may comprise optionally purifying and then electrolyzing the produced water to produce at least hydrogen and oxygen; storing, selling, releasing, or converting oxygen to a useful oxygen product; and storing, selling, releasing, or converting hydrogen to a useful hydrogen product and to produce fresh water for beneficial reuse. Alternatively or additionally, the optionally purified produced water may be subjected to steam reformation with methane to produce carbon dioxide and hydrogen which can be used as desired.

### CROSS-REFERENCE TO RELATED APPLICATIONS

The present application claims priority to U.S. Provisional Application No. 63/298,516 filed Jan. 11, 2022 and U.S. Provisional Application No. 63/339,122 filed May 6, 2022, each of which is incorporated herein by reference.

### FIELD OF THE DISCLOSURE

The present disclosure relates to systems and methods for using produced water from oil and gas wells to make hydrogen and/or fresh water.

### BACKGROUND AND SUMMARY

Hydrogen is one of the more important options for future clean energy while produced water from, for example, oil and gas wells due to production or fracking often poses significant issues related to, for example, handling, disposal, and/or reuse. What are needed are solutions that mitigate issues related to excessive produced water production and/or potentially leverage produced water for resources such hydrogen and/or fresh water.

Advantageously, the instant application pertains to new systems and methods for using produced water from oil and gas wells to make hydrogen and/or fresh water.

In one embodiment the application pertains to a process that may comprise, if necessary, purifying and then electrolyzing the produced water to produce at least hydrogen and oxygen; storing, selling, releasing, or converting oxygen to a useful oxygen product; and storing, selling, releasing, or converting hydrogen to a useful hydrogen product.

In one embodiment the application pertains to a process that may comprise, if necessary, purifying and then steam reforming the produced water with methane to produce at least hydrogen and carbon dioxide; capturing, storing, selling, releasing, injecting, or converting carbon dioxide to a useful product; and storing, selling, releasing, or converting hydrogen to a useful hydrogen product.

These and other objects, features and advantages of the exemplary embodiments of the present disclosure will become apparent upon reading the following detailed description of the exemplary embodiments of the present disclosure, when taken in conjunction with the appended claims.

### BRIEF DESCRIPTION OF THE DRAWINGS

Various embodiments of the present disclosure, together with further objects and advantages, may best be understood by reference to the following description taken in conjunction with the accompanying drawings.

FIG. 1 shows a representative concept pertaining to using produced water from oil and gas wells to make hydrogen and/or fresh water

FIG. 2 shows a representative process flow for using produced water from oil and gas wells to make hydrogen and/or oxygen.

FIG. 3 shows a representative process flow for using using produced water from oil and gas wells to make hydrogen and/or fresh water.

### DETAILED DESCRIPTION

The following description of embodiments provides a non-limiting representative examples referencing numerals to particularly describe features and teachings of different aspects of the invention. The embodiments described should be recognized as capable of implementation separately, or in combination, with other embodiments from the description of the embodiments. A person of ordinary skill in the art reviewing the description of embodiments should be able to learn and understand the different described aspects of the invention. The description of embodiments should facilitate understanding of the invention to such an extent that other implementations, not specifically covered but within the knowledge of a person of skill in the art having read the description of embodiments, would be understood to be consistent with an application of the invention.

### General Process

The instant application pertains to a process that may comprise, if necessary, purifying and electrolyzing the produced water to produce at least hydrogen and oxygen; storing, selling, releasing, or converting oxygen to a useful oxygen product; and storing, selling, releasing, or converting hydrogen to a useful hydrogen product and/or, if desired, producing fresh water suitable for beneficial use.

The instant application also pertains to a process that may comprise, if necessary, purifying and then using the produced water in a steam reformation process with methane to produce at least hydrogen and carbon dioxide; capturing the carbon dioxide and/or or converting it to a useful product; and storing, selling, releasing, or converting hydrogen to a useful hydrogen product and/or, if desired, producing fresh water suitable for beneficial use from a concentrated saltwater stream that results from the steam reformation.

Depending upon the particular type of water the produced water may be treated before electrolyzing or steam reforming to, for example, remove and/or reduce contaminates that could deleteriously effect the electrolyzing or steam reforming. The type of treatments are not particularly limited and may vary depending upon the specification required for the electrolyzing. That is, in some embodiments the treating may comprise desalinizing, e.g., remove NaCl and/or other salts, metals, or organic materials that may or may not affect the electrolysis or steam reforming.

The electrolyzing may employ an electrolysis tank. The temperature and other parameters of such tanks may be controlled as necessary. The tanks may be open like ponds or in some embodiments the tanks are enclosed. The processes may further comprise producing a concentrated saltwater, desalinating a waste stream, disposing of a waste stream, and/or removing a waste stream comprising minerals from the electrolysis tank. Disposal may be in any convenient method or manner and in some embodiments may comprise disposing at least a portion of a waste stream in a salt water disposal well. If the waste stream comprises a solid then at least a portion of it may be separated from the waste stream and potentially disposed of in a landfill.

As described above, in some embodiments, steam reformation may be employed instead of or in addition or simultaneous to electrolysis. In such embodiments methane is either produced on site or purchased. A produced water is treated as necessary to be suitable for steam reformation. The methane and produced water undergo steam reformation to produce carbon dioxide and hydrogen. If desired, the carbon dioxide may be captured for sequestration or beneficial use. The hydrogen may be stored, converted to electricity with solar, sold, or used in some other beneficial way. The waste water may be recycled, desalinated, and/or injected into a saltwater disposal well. Advantageously, the processes described above may be varied depending upon local regulations, carbon tax credits, and other factors to optimize savings while benefitting the environment.

In some embodiments the produced hydrogen may be converted to electrical power. In some embodiments the produced hydrogen may be employed to power electrolyzing, desalinizing, or both.

### Representative Embodiments, Advantages, and Related Information

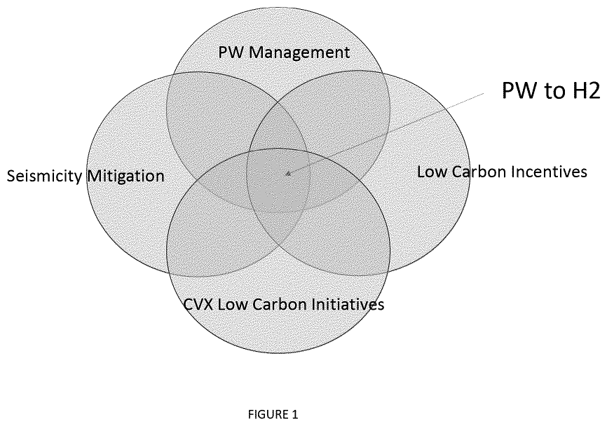

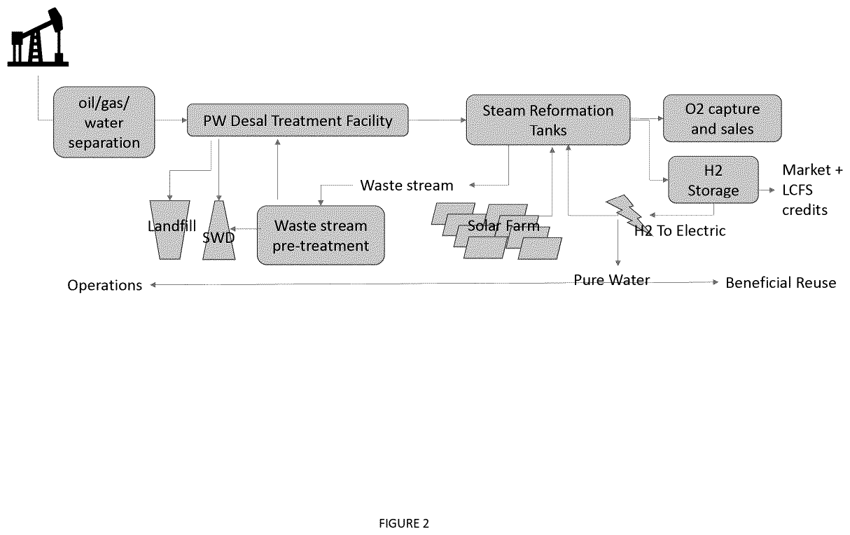

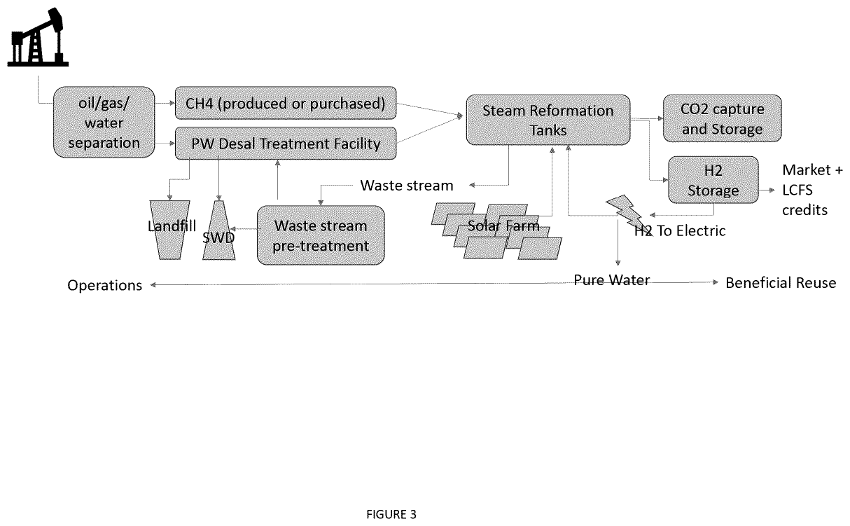

FIGS. 1-6 show representative concepts and related information pertaining to using produced water from oil and gas wells to make hydrogen and/or fresh water.

In the preceding specification, various embodiments have been described with references to the accompanying drawings. It will, however, be evident that various modifications and changes may be made thereto, and additional embodiments may be implemented, without departing from the broader scope of the invention as set forth in the claims that follow. The specification and drawings are accordingly to be regarded as an illustrative rather than restrictive sense.

Turning a Liability into an Asset:

Our ability to operate an unconventional program is intrinsically tied to our ability to manage PW safely. Due to IS, finding alternatives to injection is a requisite but may also present opportunities.

Option 1: Electrolysis.

A concept to mitigate risk of disposal limitations while supporting clean energy initiatives.

Primary purpose: preserve freedom to operate conventionals by reducing disposal volumes.

Secondary benefits: a Green hydrogen operation with O2, H2O and other by-products.

Beneficial Reuse: “new” water created from this process may surpass quality standards achieved through conventional filtering and distillation methods.

Remaining risk: this does not eliminate the need for disposal— only reduces it.

Key Features

Conversion of largely desalinated produced water to H2/O2 through electrolysis.

Produced H2 and solar combine to perpetuate a clean, green electrolysis process.

H2 production reduces disposal requirements while capturing value and LCFS incentives.

H2/electric conversion produces pure water for reuse (beneficial or operations) As a capital-intensive endeavor, cost sharing and tolling should be considered.

Produced water is desalinated/cleaned to electrolysis specs. Specs determined by operational efficiency and maintenance costs.

Electrolysis generates O2 and H2 with a concentrated saltwater stream that is recycled or disposed.

H2 to be marketed or provide electricity for electrolysis at night. Water “exhaust” available for operations or beneficial reuse.

Solar zero emissions power for Electrolysis and Desal facility (Solar during day, H2 at night), make the H2 “green”.

A concentrated waste stream is continuously pulled from pond to mitigate mineral precipitation in pond

Waste stream is treated for re-desal or disposal in SWD. Solid waste to landfill, minimizes risk to SWD operation.

Option 2: Steam Reformation.

A concept to mitigate risk of disposal limitations while supporting clean energy initiatives.

Primary purpose: preserve freedom to operate conventionals by reducing disposal volumes.

Secondary benefits: a designated Green or Blue hydrogen operation eligible for incentives.

Beneficial Reuse: “new” water created from this process may surpass quality standards achieved through conventional filtering and distillation methods.

Remaining risk: this does not eliminate the need for disposal—only reduces it.

Key Features

Conversion of produced water to H2/CO2 through low-cost steam reformation

Produced H2 and solar combine to perpetuate a low-carbon footprint

H2 production reduces disposal volumes, providing some mitigation of disposal related risk

H2/electric conversion produces pure water for reuse (beneficial or operations) As a capital-intensive endeavor, cost sharing and tolling should be considered.

Produced water is desalinated/cleaned to steam reformation standards determined by optimal efficiency and maintenance costs.

Methane steam reformation generates CO2 and H2 with a concentrated saltwater stream that can be recycled or disposed of directly.

CO2 can be captured for sequestration, rendering a very-low carbon footprint and qualifying for low-carbon credits.

H2 to be marketed or used to provide electricity for operations. Water “exhaust” available for operations or beneficial reuse.

Available methane, solar and/or H2 could provide power and heat, further qualifying the process for low-carbon benefits.

A concentrated waste stream is continuously pulled from the reformation tanks to mitigate mineral precipitation, cleaning agents.

Waste stream is treated for re-desal or SWD injection. Combine with CO2 stream if allowed. Solid waste to landfill minimizes SWD.

Alternative 2:

Power generation from solar and H2 in the original application (Option 1) is optional in the new process if CH4/Steam Reformation with carbon sequestration satisfies low carbon designation requirements.

Choice of power generation may depend on local regulation and availability of various options. It does not fundamentally change the method.

We claim:

1. A process for remediating a produced water from an oil or gas well comprising:
optionally purifying the produced water;
electrolyzing the produced water to produce at least hydrogen and oxygen;
storing, selling, releasing, or converting oxygen to a useful oxygen product; and
storing, selling, releasing, or converting hydrogen to a useful hydrogen product.

2. The process of claim 1 which further comprises treating the produced water before electrolyzing.

3. The process of claim 2 wherein the treating comprises desalinizing.

4. The process of claim 1 wherein the hydrogen is converted to electrical power and fresh water for beneficial reuse.

5. The process of claim 1 wherein the process further comprises producing concentrated saltwater.

6. The process of claim 1 wherein the electrolyzing employs an electrolysis tank.

7. The process of claim 6 wherein the process further comprises removing a waste stream comprising minerals from the electrolysis tank.

8. The process of claim 7 which further comprises desalinating the waste stream, disposing the waste stream, or any combination thereof.

9. The process of claim 7 wherein the waste stream comprises minerals.

10. The process of claim 8 wherein the waste stream is disposed in a salt water disposal well.

11. The process of claim 7 wherein the waste stream comprises a solid and wherein the solid is separated from the waste stream.

12. The process of claim 11 which further comprises disposing the solid in a landfill.

13. The process of claim 1 wherein the electrolyzing is powered by solar energy, wind energy, produced hydrogen, or a combination thereof.

14. The process of claim 8 wherein the desalinating is powered by solar energy, wind energy, produced hydrogen, or a combination thereof.

15. A process for remediating a produced water from an oil or gas well comprising:
optionally purifying the produced water;
steam reforming the produced water with methane to produce at least hydrogen and carbon dioxide;
capturing or converting carbon dioxide to a useful product; and
storing, selling, releasing, or converting hydrogen to a useful hydrogen product.

16. The process of claim 15 which further comprises treating the produced water before steam methane reforming.

17. The process of claim 16 wherein the treating comprises desalinizing.

18. The process of claim 15 wherein the hydrogen is converted to electrical power and fresh water for beneficial reuse.

19. The process of claim 15 wherein the process further comprises producing concentrated saltwater.

20. The process of claim 15 wherein the steam reforming employs a steam reforming tank.

21. The process of claim 20 wherein the process further comprises removing a waste stream comprising minerals from the steam reforming tank.

22. The process of claim 15 which further comprises desalinating a waste stream, disposing a waste stream, or any combination thereof.

23. The process of claim 22 wherein the waste stream comprises minerals.

24. The process of claim 22 wherein the waste stream is disposed in a salt water disposal well.

25. The process of claim 22 wherein the waste stream comprises a solid and wherein the solid is separated from the waste stream.

26. The process of claim 25 which further comprises disposing the solid in a landfill.

27. The process of claim 15 wherein the steam reforming is powered by solar energy, wind energy, produced hydrogen, or a combination thereof.

28. The process of claim 17 wherein the desalinating is powered by solar energy, wind energy, produced hydrogen, or a combination thereof.
